(19) United States
(12) Patent Application Publication
(10) Pub. No.: US 2021/0111800 A1
(43) Pub. Date: Apr. 15, 2021

(54) OPTICAL AMPLIFIER, OPTICAL TRANSMISSION DEVICE, AND OPTICAL TRANSMISSION SYSTEM

(71) Applicant: FUJITSU LIMITED, Kawasaki-shi (JP)

(72) Inventors: Masao Nakata, Kawasaki (JP); Takashi Sato, Kawasaki (JP); KAZUNARI TSUBAKI, Kawasaki (JP)

(73) Assignee: FUJITSU LIMITED, Kawasaki-shi (JP)

(21) Appl. No.: 17/007,740

(22) Filed: Aug. 31, 2020

(30) Foreign Application Priority Data
Oct. 10, 2019 (JP) 2019-186869

(51) Int. Cl. H04B 10/291; H01S 3/30; H01S 3/067

(52) U.S. Cl. CPC H04B 10/2916; H04B 2210/003; H01S 3/06754; H01S 3/302

(57) ABSTRACT

An optical amplifier includes a light source that generates excitation light in a wavelength band for Raman-amplifying signal light, an input unit that inputs the signal light and the excitation light to an optical fiber, and a processor connected to the light source. The processor executes a process including: acquiring a gain reduction amount of Raman amplification according to power of the signal light input to the optical fiber; determining a target gain based on the gain reduction amount acquired; judging whether a Raman gain corresponding to power of spontaneous emission light generated when the signal light is Raman-amplified in the optical fiber achieves the target gain determined; and setting power of the excitation light according to a judging result at the judging.

### CROSS-REFERENCE CO RELATED APPLICATION

This application is based upon and claims the benefit of priority of the prior Japanese Patent Application No. 2019-186869, filed on Oct. 10, 2019, the entire contents of which are incorporated herein by reference.

### FIELD

The embodiments discussed herein are related to an optical amplifier, an optical transmission device, and an optical transmission system.

### BACKGROUND

In recent years, in wavelength division multiplexing (WDM) optical transmission systems, in order to increase the transmission distance and transmission capacity, optical signal to noise ratio (OSNR) deterioration due to optical loss of optical fibers is compensated using a Raman optical amplifier. A backward Raman amplification method in which signal light is amplified using excitation light propagating in the direction opposite to the signal light on the downstream side of an optical fiber where the signal light power is relatively small, is conventionally often adopted.

As a key technology to improve the OSNR for achieving long-distance WDM optical transmission, it has been considered to adopt a bidirectional Raman amplification configuration in which a forward Raman amplification method using excitation light propagating in the same direction as the signal light on the upstream side of the optical fiber and the backward Raman amplification method described above are used in combination. With the bidirectional Raman amplification configuration, it is possible to expand the transmission capacity by adopting a multilevel high-speed transmission method (for example, 400 Gb/s or more) that requires reduction in nonlinear optical phenomena in the optical signal input to the optical fiber. Furthermore, loss characteristics in the propagation direction of the optical fiber are flattened by Raman optical amplification, and the OSNR can be improved to lengthen the transmission distance.

The Raman optical amplifier has a characteristic in which the Raman gain saturates and the gain reduces as the power of the signal light increases. That is, for example, as illustrated in FIG. 16, when the power of the signal light (input light power) input to the Raman optical amplifier increases, the Raman gain of the Raman optical amplifier saturates and the gain reduces. For this reason, the forward Raman amplification method that amplifies the signal light on the upstream side of the optical fiber having relatively large signal light power is easily affected by the gain reduction due to gain saturation. Specifically, in the example illustrated in FIG. 16, when the signal light power changes from 0 dBm to 20 dBm, for example, the Raman gain is reduced by 4.2 dB due to gain saturation, and a desired Raman gain fails to be obtained. As a result, the power of the signal light is reduced in the receiver, the OSNR is deteriorated, and an error may occur. To address this, it has been considered to change the power of the excitation light according to the power of the signal light to compensate for the decrease in the Raman gain due to saturation. Specifically, when the signal light power increases, the excitation light power is increased to increase the gain, thereby compensating for the decrease in the Raman gain due to saturation.

Patent Document 1: Japanese Laid-open Patent Publication No. 2005-309250

Patent Document 2: Japanese Laid-open Patent Publication No. 2001-222036

Patent Document 3: Japanese Laid-open Patent Publication No. 2016-212370

However, when the power of the excitation light is changed according to the power of the signal light, there is a problem in that it is uncertain whether the Raman gain of the Raman optical amplifier has reached a desired target gain. In other words, although a reduction in the Raman gain due to gain saturation can be compensated to some extent simply by uniformly determining the excitation light power with respect to the signal light power, a desired target gain may fail to be achieved depending on the characteristics of the optical fiber, for example. If the target gain is not achieved, the signal quality such as OSNR is deteriorated, and the possibility that an error will occur increases.

### SUMMARY

According to an aspect of an embodiment, an optical amplifier includes a light source that generates excitation light in a wavelength band for Raman-amplifying signal light, an input unit that inputs the signal light and the excitation light to an optical fiber, and a processor connected to the light source. The processor executes a process including: acquiring a gain reduction amount of Raman amplification according to power of the signal light input to the optical fiber; determining a target gain based on the gain reduction amount acquired; judging whether a Raman gain corresponding to power of spontaneous emission light generated when the signal light is Raman-amplified in the optical fiber achieves the target gain determined; and setting power of the excitation light according to a judging result at the judging.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of an optical transmission system according to a first embodiment;

FIG. 2 is a block diagram illustrating a configuration of a control unit according to the first embodiment;

FIG. 3 is a diagram illustrating a specific example of a gain reduction amount table;

FIG. 4 is a diagram illustrating a specific example of a gain/ASE light correlation table;

FIG. 5 is a flowchart illustrating an optical amplification method according to the first embodiment;

FIG. 6 is a diagram illustrating a specific example of variations in Raman gain;

FIG. 7 is a block diagram illustrating a configuration of an optical transmission system according to a second embodiment;

FIG. 8 is a block diagram illustrating a configuration of a control unit according to the second embodiment;

FIG. 9 is a flowchart illustrating a startup process of an optical sending device according to the second embodiment;

FIG. 10 is a flowchart illustrating an optical fiber loss measurement process;

FIG. 11 is a flowchart illustrating a secondary excitation light power determination process;

FIG. 12 is a flowchart illustrating a gain reduction amount measurement process;

FIG. 13 is a diagram illustrating a specific example of fluctuations in Raman gain;

FIG. 14 is a block diagram illustrating a configuration of an optical transmission system according to a third embodiment;

FIG. 15 is a block diagram illustrating a configuration of an optical transmission system according to a fourth embodiment; and

FIG. 16 is a diagram illustrating a specific example of gain saturation characteristics.

### DESCRIPTION OF EMBODIMENTS

Preferred embodiments of the present invention will be explained with reference to accompanying drawings. Note that the present invention is not limited to these embodiments.

### [a]First Embodiment

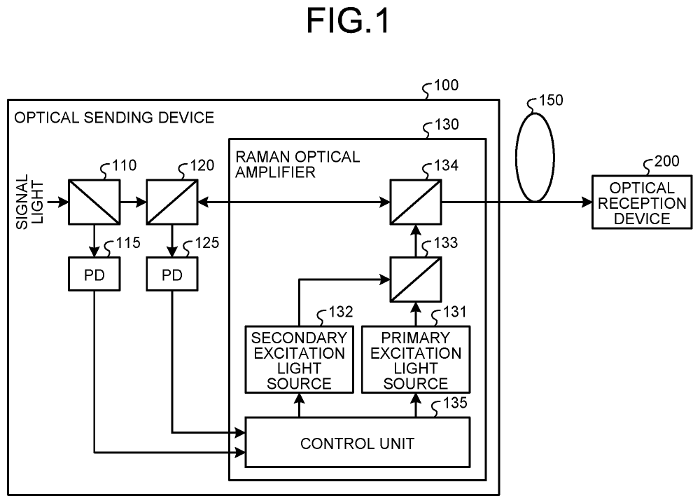

FIG. 1 is a block diagram illustrating a configuration of an optical transmission system according to a first embodiment. The optical transmission system illustrated in FIG. 1 includes an optical sending device 100 and an optical reception device 200 connected through an optical fiber 150. The optical sending device 100 includes optical demultiplexers 110 and 120, photodetectors (PD: Photo Diode) 115 and 125, and a Raman optical amplifier 130.

The optical demultiplexer 110 demultiplexes signal light when the signal light is input, outputs one signal light to the optical demultiplexer 120, and outputs the other signal light to the PD 115.

The PD 115 detects the power of the signal light output from the optical demultiplexer 110 and notifies the Raman optical amplifier 130 of the detected signal light power.

The optical demultiplexer 120 outputs the signal light output from the optical demultiplexer 110 to the Raman optical amplifier 130. Furthermore, the optical demultiplexer 120 induces spontaneous emission light (ASE: Amplified Spontaneous Emission), which is generated along with the optical amplification in the Raman optical amplifier 130 and propagates in a direction opposite to the excitation light used for optical amplification, to the PD 125.

The PD 125 detects the power of the ASE light output from the optical demultiplexer 120 and notifies the Raman optical amplifier 130 of the detected ASE light power.

The Raman optical amplifier 130 Raman-amplifies the signal light using the excitation light. In this process, the Raman optical amplifier 130 optically amplifies primary excitation light capable of optically amplifying the wavelength band of the signal light with secondary excitation light, and optically amplifies the signal light using the optically amplified primary excitation light. The Raman optical amplifier 130 then adjusts the power of the primary excitation light and the power of the secondary excitation light while monitoring the ASE light power so that the gain reduction due to the saturation of the Raman gain is compensated and the target gain is achieved.

Specifically, the Raman optical amplifier 130 includes a primary excitation light source 131, a secondary excitation light source 132, optical multiplexers 133 and 134, and a control unit 135.

The primary excitation light source 131 generates the primary excitation light having a wide line width in a wavelength band for Raman-amplifying the signal light. For example, the primary excitation light source 131 generates ASE light having a wide line width in a wavelength hand smaller by a predetermined width than the wavelength band of the signal light. The primary excitation light source 131 sets primary excitation light power according to instructions from the control unit 135.

The secondary excitation light source 132 generates the secondary excitation light in a wavelength band for Raman-amplifying the primary excitation light. The secondary excitation light source 132 sets secondary excitation light power according to instructions from the control unit 135.

The optical multiplexer 133 multiplexes the primary excitation light and the secondary excitation light, and outputs the obtained multiplexed excitation light to the optical multiplexer 134.

The optical multiplexer 134 multiplexes the multiplexed excitation light and the signal light, and inputs the multiplexed excitation light and the signal light to the optical fiber 150. In the optical fiber 150, the primary excitation light is Raman-amplified with the secondary excitation light, and the signal light is Raman-amplified with the Raman-amplified primary excitation light.

Based on the signal light power, and the ASE light power associated with Raman light amplification, the control unit 135 adjusts the power of the primary excitation light and the power of the secondary excitation light so that the gain reduction due to the saturation of the Raman gain is compensated and the target gain is achieved. That is, the control unit 135 acquires the gain reduction amount due to the saturation of the Raman gain corresponding to the signal light power, based on the signal light power notified from the PD 115. The control unit 135 then determines whether the target gain in consideration of the gain reduction amount is achieved based on the ASE light power notified from the PD 125, and adjusts the power of the primary excitation light and the power of the secondary excitation light according to the determination result.

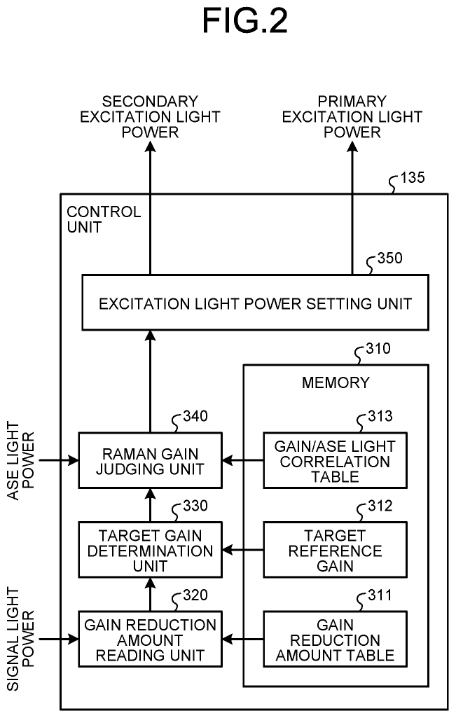

FIG. 2 is a block diagram illustrating a configuration of the control unit 135 according to the first embodiment. The control unit 135 illustrated in FIG. 2 includes a memory 310, a gain reduction amount reading unit 320, a target gain determination unit 330, a Raman gain judging unit 340, and an excitation light power setting unit 350.

The memory 310 stores various kinds of information used for determining the excitation light power. Specifically, the memory 310 stores a gain reduction amount table 311, a target reference gain 312, and a gain/ASE light correlation table 313.

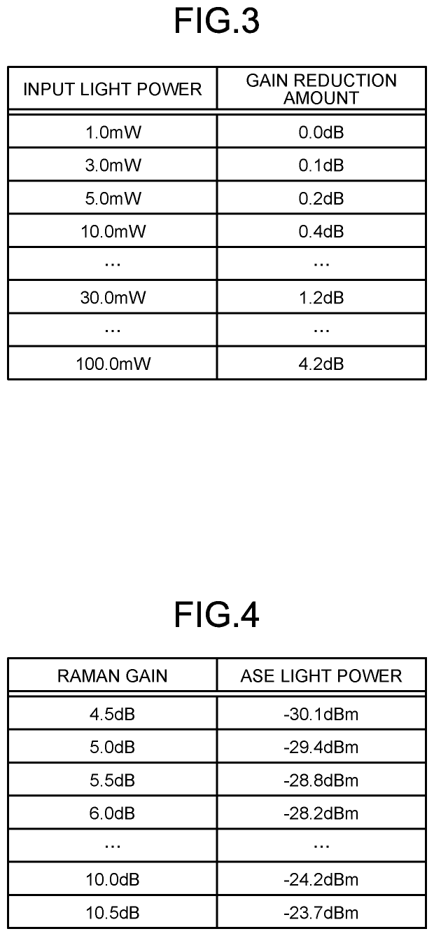

The gain reduction amount table 311 stores the gain reduction amount due to the saturation of the Raman gain in association with the signal light power. Specifically, for example, as illustrated in FIG. 3, the gain reduction amount table 311 stores the gain reduction amount when the input light is Raman-amplified, in association with the power of the input light input from the Raman optical amplifier 130 to the optical fiber 150. As stored in the example illustrated in FIG. 3, for example, with the case when the input light power is 1.0 mW serving as a reference, the gain reduction amount is 0.1 dB when the input light power is 3.0 mW, and the gain reduction amount is 0.2 dB when the input light power is 5.0 mW. That is, as the input light power increases, the Raman gain is saturated and the gain reduction amount increases. The gain reduction amount stored in the gain reduction amount table 311 nay be a gain reduction amount measured by using a predetermined Raman optical amplifier serving as a reference and an optical fiber.

The target reference gain 312 is the gain of amplification needed for the optical transmission system. The target reference gain 312 increases as the length of the optical fiber 150 between the optical sending device 100 and the optical reception device 200 increases, for example. Furthermore, the target reference gain 312 increases as the error rate allowed for reception data in the optical reception device 200 increases, for example.

The gain/ASE light correlation table 313 stores the power of the ASE light generated when the input light to the optical fiber 150 is Raman-amplified and propagating in the direction opposite to the excitation light and the Raman gain in the Raman amplification in association with each other. That is, the gain/ASE light correlation table 313 stores the ASE light power corresponding to the Raman gain. Specifically, for example, as illustrated in FIG. 4, the gain/ASE light correlation cable 313 stores the power of the ASE light propagating from the optical fiber 150 in the direction of the Raman optical amplifier 130 in association with the Raman gain in the Raman amplification. As stored in the example illustrated in FIG. 4, for example, ASE light of −30.1 dBm is generated when the Raman gain is 4.5 dB, and ASE light of −29.4 dBm is generated when the Raman gain is 5.0 dB. That is, as the Raman gain increases, the power of the generated ASE light increases. The ASE light power depends on the Raman gain regardless of the characteristics of the optical fiber 150, and serves as an index of the Raman gain that can vary depending on the input light power to the optical fiber 150.

The gain reduction amount reading unit 320 acquires the signal light power notified from the PD 115, refers to the gain reduction amount table 311, and reads out the gain reduction amount according to the signal light power. The gain reduction amount reading unit 320 then notifies the target gain determination unit 330 of the read gain reduction amount.

When the gain reduction amount reading unit 320 notifies the target gain determination unit 330 of the gain reduction amount, the target gain determination unit 330 determines a target gain by adding the gain reduction amount and the target reference gain 312. That is, the target gain determination unit 330 determines the gain obtained by adding the gain reduction amount to the target reference gain 312 to be the target gain. The target gain determination unit 330 then notifies the Raman gain judging unit 340 of the target gain.

Upon being notified of the ASE light power from the PD 125, the Raman gain judging unit 340 refers to the gain/ASE light correlation table 313 and reads out the Raman gain corresponding to the notified ASE light power. The Raman gain judging unit 340 then compares the read Raman gain with the target gain notified from the target gain determination unit 330, and judges whether the Raman gain has reached the target gain. That is, the Raman gain judging unit 340 judges whether the read Raman gain is equal to or higher than the target gain. The Raman gain judging unit 340 then notifies the excitation light power setting unit 350 of the judging result.

The excitation light power setting unit 350 sets the primary excitation light power of the primary excitation light source 131 and the secondary excitation light power of the secondary excitation light source 132 based on the judging result made by the Raman gain judging unit 340. Specifically, the excitation light power setting unit 350 increases the primary excitation light power or the secondary excitation light power, or both of the excitation light power by a predetermined value when the Raman gain has not reached the target gain. In other words, the excitation light power setting unit 350 increases the Raman gain by increasing at least one of the primary excitation light power and the secondary excitation light power when the Raman gain is smaller than the target gain. The excitation light power setting unit 350 may reduce the primary excitation light power or the secondary excitation light power, or both of the excitation light power by a predetermined value when the Raman gain is larger than the target gain. That is, the excitation light power setting unit 350 may adjust the primary excitation light power and the secondary excitation light power so that the Raman gain will become equal to the target gain.

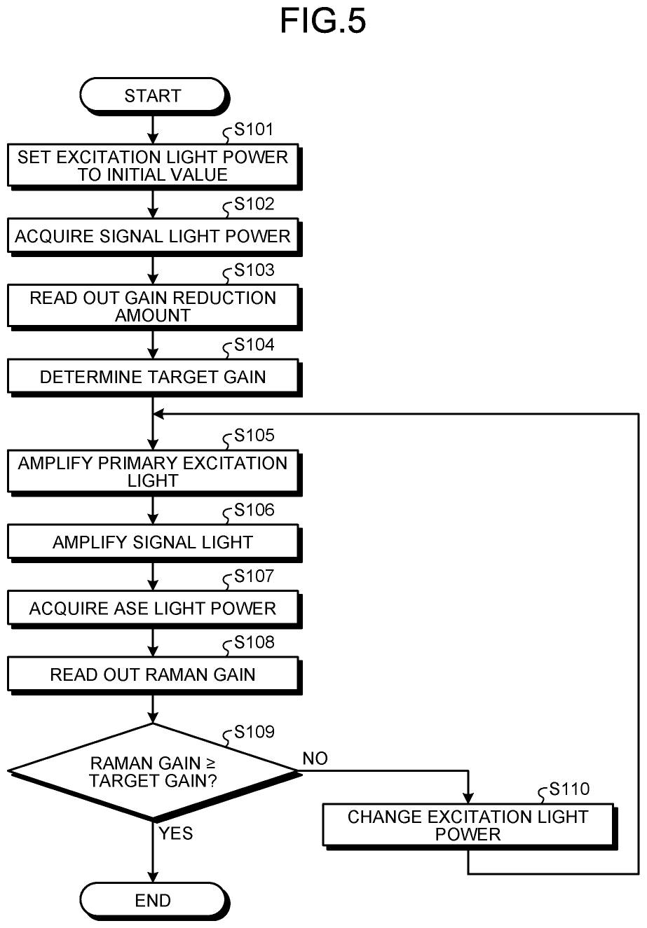

Next, an optical amplification method in the optical sending device 100 configured as described above will be described with reference to the flowchart illustrated in FIG. 5. The optical amplification method illustrated in FIG. 5 is mainly executed by the control unit 135 of the Raman optical amplifier 130.

First, the excitation light power setting unit 350 sets the primary excitation light power of the primary excitation light source 131 and the secondary excitation light power of the secondary excitation light source 132 to initial values (step S101). When the initial values are set, the signal light passes through the optical demultiplexers 110 and 120 and is input to the Raman optical amplifier 130.

Meanwhile, signal light which is the same as the signal light input to the Raman optical amplifier 130 is input from the optical demultiplexer 110 to the PD 115, and the signal light power is input to the gain reduction amount reading unit 320 (step S102). The gain reduction amount reading unit 320 then reads out the gain reduction amount according to the signal light power from the gain reduction amount table 311 (step S103). The target gain determination unit 330 is notified of the gain reduction amount, and the target gain determination unit 330 adds the gain reduction amount and the target reference gain 312 to determine a target gain (step S104). That is, the target gain is determined by adding the gain reduction amount according to the signal light power to the target reference gain 312. The Raman gain judging unit 340 is notified of the determined target gain.

The signal light input to the Raman optical amplifier 130 is input to the optical multiplexer 134. Furthermore, the primary excitation light and the secondary excitation light the power initial values of which are set are emitted from the primary excitation light source 131 and the secondary excitation light source 132, respectively, and the primary excitation light and the secondary excitation light are multiplexed by the optical multiplexer 133. The multiplexed excitation light obtained by the multiplexing is input to the optical multiplexer 134 and multiplexed with the signal light. The signal light and the multiplexed excitation light are output to the optical fiber 150, the primary excitation light is Raman-amplified with the secondary excitation light (step S105), and the signal light is Raman-amplified with the Raman-amplified primary excitation light (step S106). The Raman-amplified signal light, is propagated to the optical reception device 200 through the optical fiber 150.

In this process, with the Raman amplification, ASE light that propagates in the direction from the optical fiber 150 to the Raman optical amplifier 130, is generated. The ASE light is induced to the PD 125 by the optical demultiplexer 120, and the ASE light power is input to the Raman gain judging unit 340 (step S107). The Raman gain judging unit 340 reads out the Raman gain corresponding to the ASE light power from the gain/ASE light correlation table 313 (step S108). The read Raman gain is compared with the target gain to determine whether the Raman gain has reached the target gain (step S109).

Specifically, if the Raman gain is equal to or larger than the target gain (step S109 Yes), the Raman gain judging unit 340 judges that the target gain has been achieved. In this case, it is not needed to change the power of the primary excitation light and the power of the secondary excitation light because the Raman gain that satisfies the target reference gain 312 is obtained even if the gain reduction according to the signal light power occurs, and the process ends. If the Raman gain is larger than the target gain, the power of the primary excitation light or the power of the secondary excitation light may be reduced in order to match the Raman gain with the target gain. That is, the excitation light power setting unit 350 may adjust the primary excitation light power and the secondary excitation light power so that the Raman gain will become equal to the target gain.

On the other hand, if the Raman gain is smaller than the target gain (step S109 No), the Raman gain judging unit 340 judges that the target gain has not been achieved. In this case, the excitation light power setting unit 350 changes the primary excitation light, power or the secondary excitation light power, or both of the excitation light power (step S110). Specifically, the excitation light power setting unit 350 increases at least one of the primary excitation light power and the secondary excitation light power by a predetermined value. The primary excitation light is then Raman-amplified again with the excitation light power increased (step S105), and the signal light is Raman-amplified (step S106), whereby the signal light is Raman-amplified with a larger Raman gain. As a result, the power of the ASE light generated in the Raman amplification also increases, and the Raman gain corresponding to the ASE light power approaches the target gain.

In this way, whether the Raman gain has reached the target gain is judged based on the ASE light power generated in the Raman amplification, and thus the primary excitation light power and the secondary excitation light power can be adjusted while checking whether the target gain is achieved. As a result, the primary excitation light power and the secondary excitation light power can be set so that the target gain can be reliably achieved regardless of the characteristics of the optical fiber 150, for example.

As described above, according to the present embodiment, the target gain is determined by adding the gain reduction amount according to the signal light power to the target reference gain, and the primary excitation light power and the secondary excitation light power are adjusted while checking whether the Raman gain reaches the target gain based on the ASE light power generated in the Raman amplification of the signal light. Therefore, even if the signal light power increases and a gain reduction due to the saturation of the Raman gain occurs, it is possible to Raman-amplify the signal light by setting the excitation light power that can reliably satisfy the target reference gain. As a result, deterioration of signal quality due to gain saturation can be suppressed.

### [b] Second Embodiment

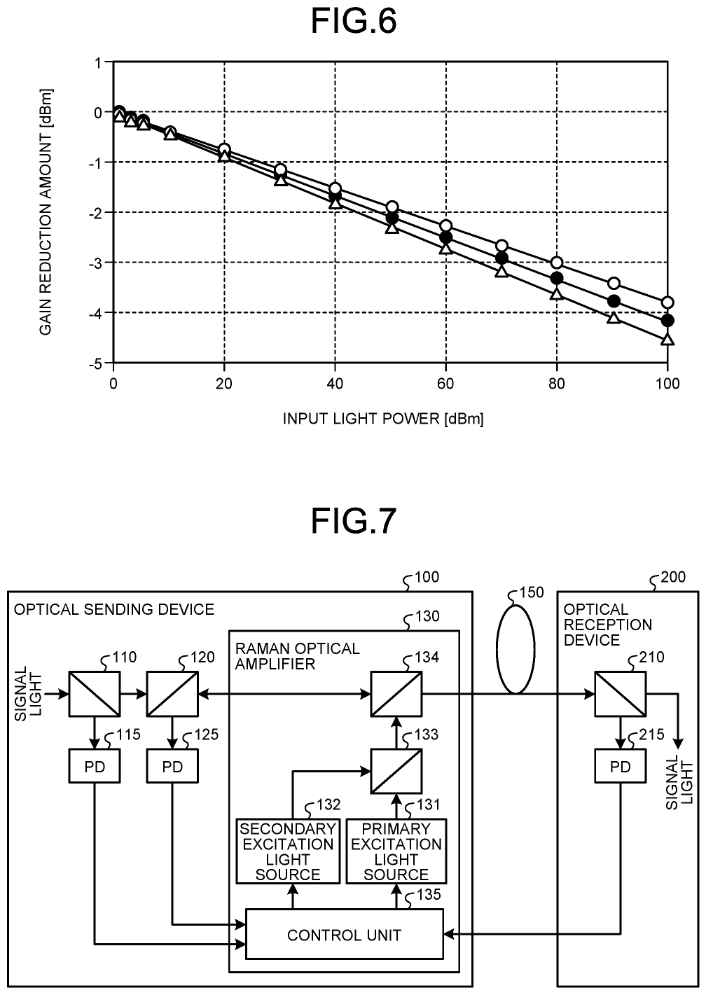

In the first embodiment, the gain reduction amount table 311 is assumed to be stored in the memory 310 of the Raman optical amplifier 13C in advance. However, the gain reduction due to the saturation of the Raman gain varies depending on the characteristics of the optical fiber, for example, and the relationship between the signal light power and the magnitude of the Raman gain is not always constant. Specifically, as illustrated in FIG. 6, for example, the gain reduction amount due to the saturation of the Raman gain when the power of the input light input to the optical fiber increases depends on the characteristics of the optical fiber and the like. FIG. 6 is a diagram illustrating the relationship between the power of the input light and the gain reduction amount for three different optical fibers. As illustrated in FIG. 6, as the input light power increases, the Raman gain reduction amount increases, and variations in the gain reduction amount for respective optical fibers increase accordingly. Therefore, in a second embodiment, a case will be described where a gain reduction amount table corresponding to the optical fiber 150 is created when, for example, the optical sending device 100 is started.

FIG. 7 is a block diagram illustrating a configuration of an optical transmission system according to the second embodiment. In FIG. 7, the same parts as those in FIG. 1 are designated by the same reference numerals, and the description thereof will be omitted. The optical transmission system illustrated in FIG. 7 includes an optical sending device 100 and an optical reception device 200 connected through an optical fiber 150. The optical sending device 100 has the same configuration as the optical sending device 100 in the first embodiment. The optical reception device 200 includes an optical demultiplexer 210 and a PD 215.

The optical demultiplexer 210 receives the signal light and the excitation light propagated through the optical fiber 150, demultiplexes the primary excitation light from the received light, and outputs the demultiplexed primary excitation light to the PD 215.

The PD 215 detects the power of the primary excitation light output from the optical demultiplexer 210, and notifies the control unit 135 in the optical sending device 100 of the detected primary excitation light power.

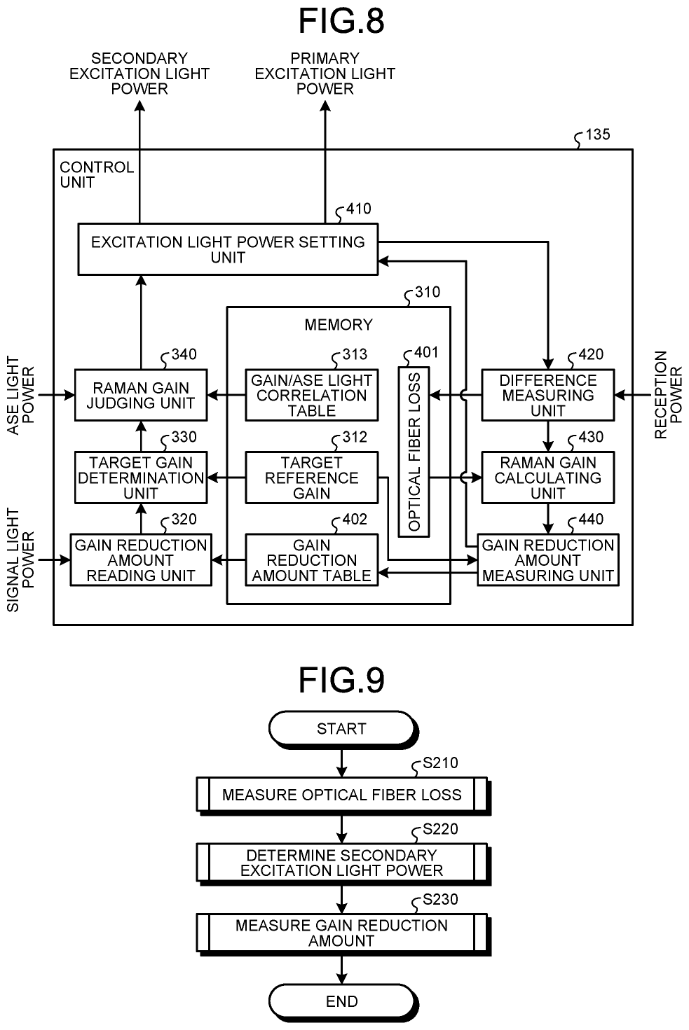

FIG. 8 is a block diagram illustrating a configuration of the control unit 135 according to the second embodiment. In FIG. 8, the same parts as those in FIG. 2 are designated by the same reference numerals, and the description thereof will be omitted. The control unit 135 illustrated in FIG. 8 includes an excitation light power setting unit 410 in place of the excitation light power setting unit 350 illustrated in FIG. 2, and has a configuration in which a difference measuring unit 420, a Raman gain calculating unit 430, and a gain reduction amount measuring unit 440 are added.

The excitation light power setting unit 410 operates similarly as the excitation light power setting unit 350 according to the first embodiment when the optical sending device 100 sends signal light. That is, the excitation light power setting unit 410 sets the primary excitation light power of the primary excitation light source 131 and the secondary excitation light power of the secondary excitation light source 132 based on the judging result made by the Raman gain judging unit 340.

In addition, in order to measure the gain reduction amount according to the primary excitation light power when the optical sending device 100 is started, the excitation light power setting unit 410 sets the primary excitation light power of the primary excitation light source 131 and the secondary excitation light power of the secondary excitation light source 132 according to instructions from the gain reduction amount measuring unit 440.

The difference measuring unit 420 acquires the primary excitation light power set for the primary excitation light source 131 by the excitation light power setting unit 410 (hereinafter referred to as “set power”), and acquires the primary excitation light power detected by the PD 215 of the optical reception device 200 (hereinafter referred to as “reception power”). The difference measuring unit 420 then calculates the difference between the set power and the reception power and outputs it to the Raman gain calculating unit 430. The difference measuring unit 420 also stores the difference between the set power and the reception power when the secondary excitation light power is set to 0 in the memory 310 as an optical fiber loss 401. That is, when the secondary excitation light power is 0, the primary excitation light is not Raman-amplified, and the difference between the set power and the reception power corresponds to the propagation loss in the optical fiber 150 and is thus stored as the optical fiber loss 401.

When the difference measuring unit 420 outputs the difference between the set power and the reception power, based on this difference and the optical fiber loss 401, the Raman gain calculating unit 430 calculates the Raman gain for Raman-amplifying the primary excitation light with the secondary excitation light. Specifically, the Raman gain calculating unit 430 calculates the Raman gain by subtracting the difference between the set power and the reception power from the optical fiber loss 401. As described above, when the secondary excitation light power is 0, the primary excitation light is not Raman-amplified, and therefore the difference between the set power and the reception power is equal to the optical fiber loss 401 and the Raman gain is 0. On the ocher hand, when the secondary excitation light power is increased, the primary excitation light is Raman-amplified and the reception power is increased, so that the difference between the set power and the reception power becomes smaller than the optical fiber lose 401. In this process, since the increase in the reception power corresponds to the Raman gain, the Raman gain can be obtained by subtracting the difference between the set power and the reception power from the optical fiber loss 401.

The gain reduction amount measuring unit 440 determines the secondary excitation light power that provides a Raman gain equal to the target reference gain 312, with the set power of the primary excitation light being sufficiently small so that the saturation of the Raman gain will not occur. The gain reduction amount measuring unit 440 then sequentially changes the set power of the primary excitation light while fixing the secondary excitation light power, and measures the Raman gain reduction according to the set power. The gain reduction amount measuring unit 440 stores a gain reduction amount table 402 indicating the relationship between the input light power and the gain reduction amount in the memory 310, based on the set power and the Raman gain reduction amount.

Next, a startup process of the optical sending device 100 configured as described above will be described with reference to the flowcharts illustrated in FIGS. 9 to 12. The following process is mainly executed by the control unit 135 in the Raman optical amplifier 130 when the optical sending device 100 is started.

As illustrated in FIG. 9, when the optical sending device 100 is started, first, the optical fiber loss 401 in the optical fiber 150 is measured (step S210), and the power of the secondary excitation light with which the Raman gain for Raman-amplifying the primary excitation light is equal to the target reference gain 312 is determined using the optical fiber loss 401 (step S220). Then, the power of the secondary excitation light is fixed to the determined secondary excitation light power, the gain reduction amount when the set power of the primary excitation light is increased is measured (step S230), and the gain reduction amount table 402 is created.

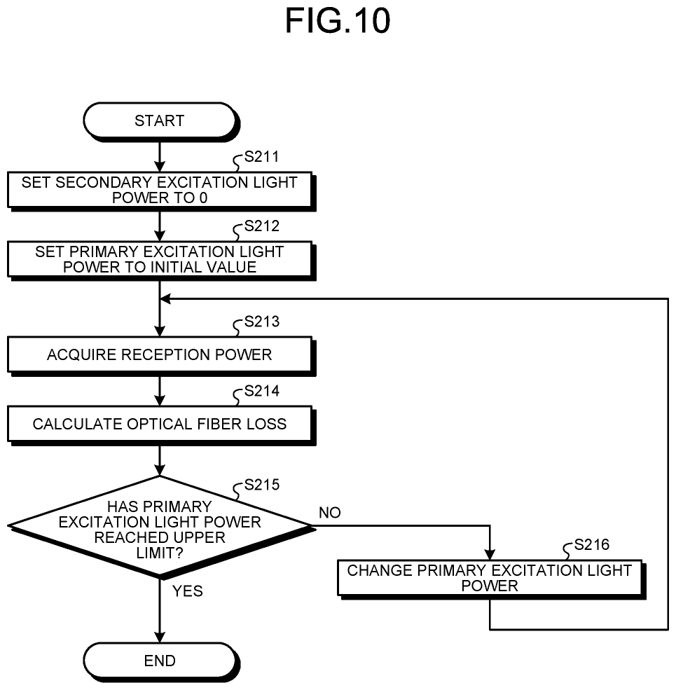

FIG. 10 is a flowchart specifically illustrating the optical fiber loss measurement process (step S210 in FIG. 9).

When the optical sending device 100 is started, the excitation light power setting unit 410 sets the secondary excitation light power to 0 according to an instruction from the gain reduction amount measuring unit 440 (step S211). Furthermore, the excitation light power setting unit 410 sets the primary excitation light power to a predetermined initial value (step S212). This initial value of the primary excitation light is a value that is sufficiently small so that the saturation of the Raman gain will not occur, and may be, for example, the minimum power with which the primary excitation light source 131 can emit light.

By setting the primary excitation light power and the secondary excitation light power in this way, the primary excitation light is propagated through the optical fiber 150 without being Raman-amplified and is received by the optical reception device 200. The power of the primary excitation light that has passed through the optical demultiplexer 210 is detected by the PD 215, and the obtained reception power is acquired by the difference measuring unit 420 in the optical sending device 100 (step S213).

The difference measuring unit 420 then acquires the set power from the excitation light power setting unit 410 and subtracts the reception power from the set power, thereby calculating the optical fiber lose 401 (step S214). That is, the difference between the set power and the reception power of the primary excitation light propagated through the optical fiber 150 without being Raman-amplified is calculated as the optical fiber loss 401. The calculated optical fiber loss 401 is stored in the memory 310.

When the optical fiber loss 401 with the set power of the primary excitation light being the initial value is calculated, the gain reduction amount measuring unit 440 determines whether the set power has reached the upper limit (step S215), and if the set power has not reached the upper limit (step S215 No), the excitation light power setting unit 410 increases the primary excitation light power by a predetermined amount (step S216). The above-described process is repeated with the set power changed, whereby the optical fiber loss 401 at each set power is calculated and stored in the memory 310. If the set power has reached the upper limit (step S215 Yes), the optical fiber loss measurement process ends.

Although the set power is changed and the optical fiber loss 401 is calculated at each set power in this example, if the optical fiber loss is constant even if the input light power to the optical fiber 150 varies, it suffices if the optical fiber loss 401 is calculated with the set power being the initial value.

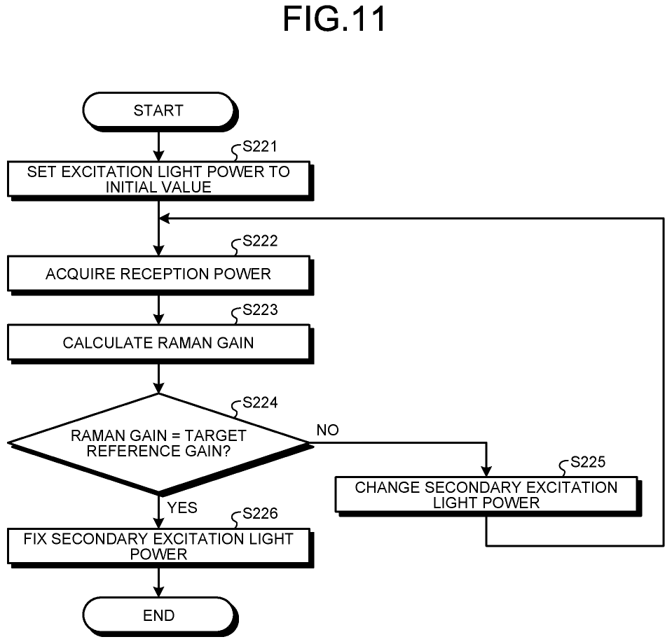

FIG. 11 is a flowchart specifically illustrating the secondary excitation light power determination process (step S220 in FIG. 9).

When the optical fiber loss 401 is stored in the memory 310, the excitation light power setting unit 410 sets the primary excitation light power and the secondary excitation light power to predetermined initial values according to an instruction from the gain reduction amount measuring unit 440 (step S221). Specifically, the primary excitation light power is set to power sufficiently small so that the saturation of the Raman gain will not occur, and the secondary excitation light power is set to, for example, the minimum power larger than 0 with which the secondary excitation light source 132 can emit light.

By setting the primary excitation light power and the secondary excitation light power in this way, the primary excitation light is Raman-amplified according to the secondary excitation light power and is received by the optical reception device 200. The power of the primary excitation light that has passed through the optical demultiplexer 210 is detected by the PD 215, and the obtained reception power is acquired by the difference measuring unit 420 in the optical sending device 100 (step S222).

The difference measuring unit 420 then acquires the set power from the excitation light power setting unit 410 and subtracts the reception power from the set power. The difference obtained by the difference measuring unit 420 is output to the Raman gain calculating unit 430, and the Raman gain calculating unit 430 subtracts the difference from the optical fiber loss 401 to calculate the Raman gain (step S223). That is, the Raman gain for Raman-amplifying the primary excitation light with the secondary excitation light is calculated. The calculated Raman gain is output to the gain reduction amount measuring unit 440.

The Raman gain is compared with the target reference gain 312 by the gain reduction amount measuring unit 440 to determine whether the Raman gain is equal to the target reference gain 312 (step S224). As a result of this determination, if the Raman gain has not reached the target reference gain 312 and is not equal to the target reference gain 312 (step S224 No), the excitation light power setting unit 410 increases the secondary excitation light power by a predetermined amount (step S225). The above-described process is repeated with the secondary excitation light power changed, whereby it is determined whether the Raman gain can achieve the target reference gain 312 with each secondary excitation light power. If the Raman gain reaches the target reference gain 312 and becomes equal to the target reference gain 312 (step S224 Yes), the excitation light power setting unit 410 fixes the secondary excitation light power (step S226), and the secondary excitation light power determination process ends.

Note that the secondary excitation light power is determined that can achieve the target reference gain 312 by gradually increasing the secondary excitation light power from the minimum power in this example, but the secondary excitation light power may be determined with which the Raman gain is equal to the target reference gain 312 by gradually decreasing the secondary excitation light power from the maximum power.

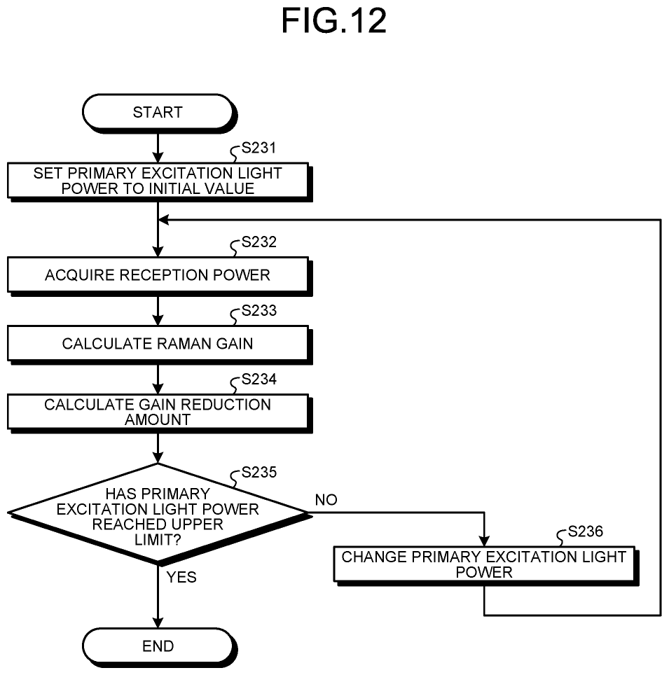

FIG. 12 is a flowchart specifically illustrating the gain reduction amount measurement process (step S230 in FIG. 9).

When the secondary excitation light power is fixed, the excitation light power setting unit 410 sets the primary excitation light power to a predetermined initial value according to an instruction from the gain reduction amount measuring unit 440 (step S231). Specifically, the primary excitation light power is set to power sufficiently small so that the saturation of the Raman gain will not occur. The initial value of the primary excitation light power may be the came as the initial value of the primary excitation light power in the above-described optical fiber loss measurement process and secondary excitation light power determination process.

Since the secondary excitation light power is fixed in this example, the primary excitation light is Raman-amplified according to the fixed secondary excitation light power and is received by the optical reception device 200. The power of the primary excitation light that has passed through the optical demultiplexer 210 is detected by the PD 215, and the obtained reception power is acquired by the difference measuring unit 420 in the optical sending device 100 (step S232).

The difference measuring unit 420 then acquires the set power from the excitation light power setting unit 410 and subtracts the reception power from the set power. The difference obtained by the difference measuring unit 420 is output to the Raman gain calculating unit 430, and the Raman gain calculating unit 430 subtracts the difference from the optical fiber loss 401 to calculate the Raman gain (step S233). That is, the Raman gain for Raman-amplifying the primary excitation light with the secondary excitation light is calculated. The calculated Raman gain is output to the gain reduction amount measuring unit 440.

Then, the gain reduction amount measuring unit 440 subtracts the Raman gain from the target reference gain 312 to calculate the gain reduction amount from the target reference gain 312 (step S234). Here, since the secondary excitation light power is fixed so as to achieve the target reference gain 312 as long as the set power is a value that is sufficiently small so that the saturation of the Raman gain will not occur, the Raman gain is equal to the target reference gain 312 with the set power being the initial value. That is, the gain reduction amount calculated by the gain reduction amount measuring unit 440 is zero.

When the gain reduction amount is calculated, the gain reduction amount measuring unit 440 stores the set power and the gain reduction amount in the gain reduction amount table 402. Subsequently, it is determined whether the set power has reached the upper limit (step S235), and if the set power has not reached the upper limit (step S235 No), the excitation light power setting unit 410 increases the primary excitation light power by a predetermined amount (step S236). The above-described process is repeated with the set power changed, whereby the gain reduction amount at each set power is calculated and stored in the gain reduction amount table 402. When the set power has reached the upper limit (step S235 Yes), the gain reduction amount measurement process ends.

As described above, in the second embodiment, when the optical sending device 100 is started, the gain reduction amount due to the saturation of the Raman gain is measured while varying the power of the primary excitation light chat is Raman-amplified with the secondary excitation light, and the correspondence between the input light power to the optical fiber 150 and the gain reduction amount is stored in the gain reduction amount table 402. This makes it possible to create the gain reduction amount table 402 according to the characteristics of the optical fiber 150. During normal operation in which the optical sending device 100 transmits signal light, as in the first embodiment, the gain reduction amount according to the signal light power is read from the gain reduction amount table 402, and the target gain is determined by adding the gain reduction amount to the target reference gain. When the target gain is determined, the primary excitation light power and the secondary excitation light power are adjusted while checking whether the Raman gain achieves the target gain based on the ASE light power generated in the Raman amplification of the signal light. That is, the optical amplification method (FIG. 5) similar to that in the first embodiment is executed.

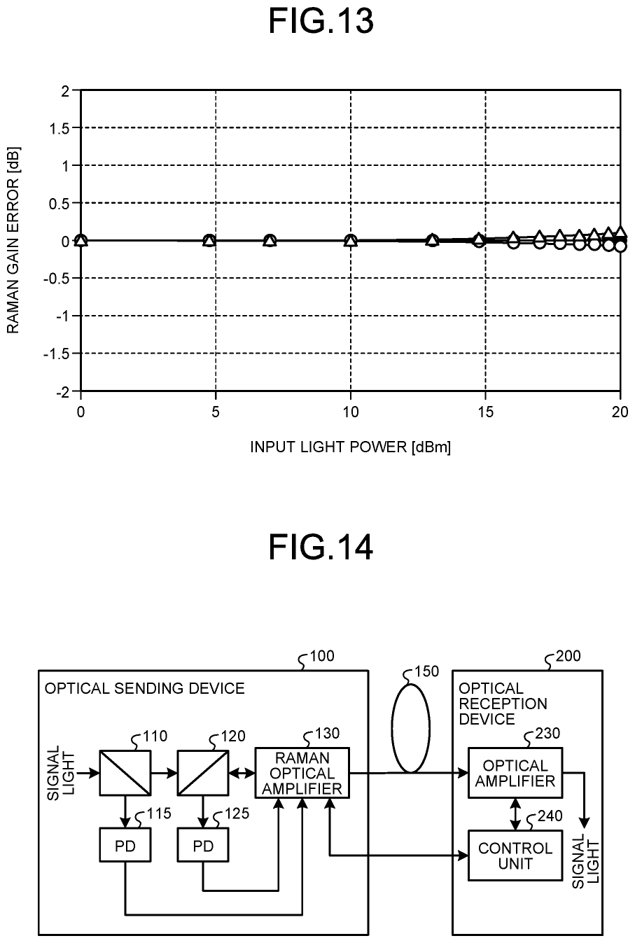

Here, since the gain reduction amount table 402 stores the gain reduction amount according to the characteristics of the optical fiber 150, the gain reduction peculiar to the optical fiber 150 is compensated, and the signal light can be Raman-amplified by setting the excitation light power that can reliably satisfy the target reference gain. In other words, for example, as illustrated in FIG. 13, even if the optical fibers are different, the gain reduction according to the characteristics of each optical fiber is compensated, and therefore, the Raman gain reduction amount due to an increase in the input light power input to each optical fiber is small. FIG. 13 is a diagram illustrating the relationship between the power of input light input to three different optical fibers and Raman gain errors with respect to the Raman gain of a reference optical fiber. As is clear from FIG. 13, even if the input light power increases, errors in the Raman gain are suppressed within about 0.1 dB.

As described above, according to the present embodiment, when the optical sending device is started, the gain reduction amount table is created by measuring the Raman gain reduction amount when the primary excitation light is Raman-amplified with the secondary excitation light, and during normal operation of the optical sending device, the created gain reduction amount table is used to compensate for the gain reduction when the signal light is Raman-amplified. It is thus possible to compensate for the gain reduction according to the signal light power using the gain reduction amount table according to the characteristics of the optical fiber, and to Raman-amplify the signal light by setting the excitation light power that can reliably satisfy the target reference gain. As a result, deterioration of signal quality due to gain saturation can be suppressed.

### [c] Third Embodiment

The feature of a third embodiment is that signal light is optically amplified by an optical reception device when the target reference gain is not achieved by Raman amplification performed by an optical sending device.

FIG. 14 is a block diagram illustrating a configuration of an optical transmission system according to the third embodiment. In FIG. 14, the same parts as those in FIG. 1 are designated by the same reference numerals, and the description thereof will be omitted. The optical transmission system illustrated in FIG. 14 includes an optical sending device 100 and an optical reception device 200 connected through an optical fiber 150. The optical sending device 100 has the same configuration as the optical sending device 100 in the first embodiment. The optical reception device 200 also includes an optical amplifier 230 and a control unit 240.

The optical amplifier 230 receives the signal light propagated through the optical fiber 150 and optically amplifies the received signal light. Specifically, the optical amplifier 230 includes a Raman optical amplifier, an erbium-doped fiber amplifier (EDFA), or the like, and according to an instruction from the control unit 240, compensates for a gain that is insufficient in Raman amplification performed by the optical sending device 100.

The control unit 240 acquires information about the insufficient gain from the Raman optical amplifier 130 in the optical sending device 100. The control unit 240 then controls the gain of the optical amplifier 230 so as to compensate for the insufficient gain.

Since the excitation light power generated by the primary excitation light source 131 and the secondary excitation light source 132 in the Raman optical amplifier 130 has upper limit, when the target reference gain 312 is large, the target reference gain 312 can fail to be achieved even with the primary excitation light power and the secondary excitation light power set to the upper limit power. In such a case, the control unit 135 in the Raman optical amplifier 130 notifies the control unit 240 in the optical reception device 200 of information about the gain that is insufficient for achieving the target reference gain 312.

The control unit 240 then controls the gain of the optical amplifier 230, and the optical amplifier 230 optically amplifies the signal light received, whereby the quality deterioration of the signal light received by the optical reception device 200 can be suppressed.

As described above, according to the present embodiment, the gain that is insufficient in Raman amplification performed by the Raman optical amplifier in the optical sending device is compensated by the optical amplifier in the optical reception device. Thus, even if the desired target reference gain is not achieved only by the optical sending device, it is possible to suppress the quality deterioration of the signal light received by the optical reception device and achieve the target reference gain in the entire optical transmission system.

### [d]Fourth Embodiment

The feature of fourth embodiment is that the signal light power input to the Raman optical amplifier is reduced when the target reference gain is not achieved in Raman amplification performed by the optical sending device.

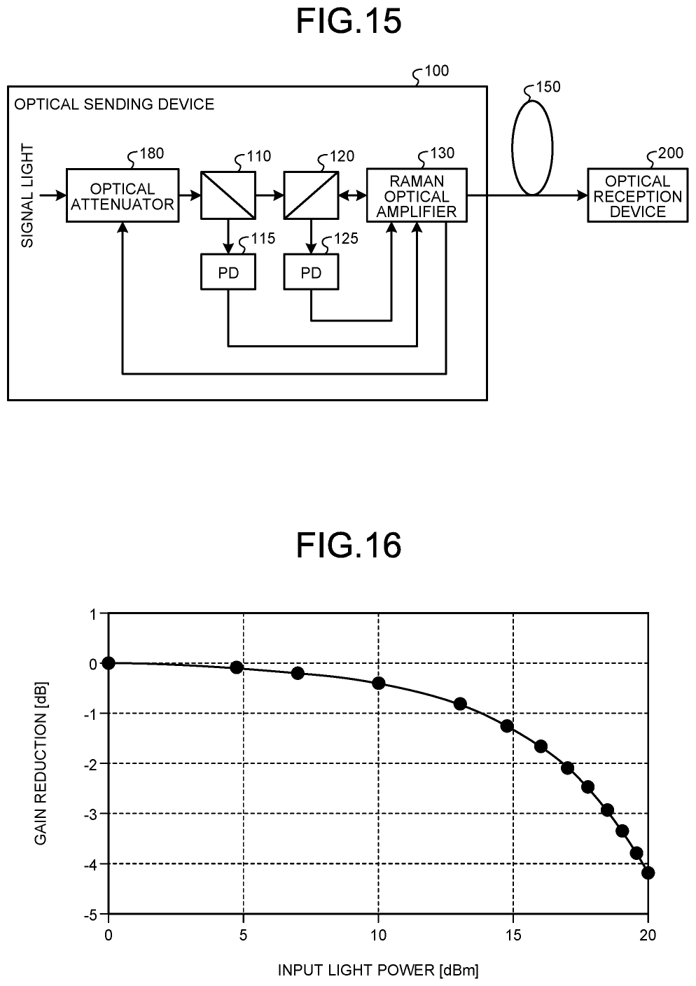

FIG. 15 is a block diagram illustrating a configuration of an optical transmission system according to the fourth embodiment. In FIG. 15, the same parts as those in FIG. 1 are designated by the same reference numerals, and the description thereof will be omitted. The optical transmission system illustrated in FIG. 15 includes an optical sending device 100 and an optical reception device 200 connected through an optical fiber 150. The optical sending device 100 has a configuration in which an optical attenuator 180 is added to the optical sending device 100 according to the first embodiment.

The optical attenuator 180 attenuates the signal light and reduces the signal light power input to the Raman optical amplifier 130 when the gain reduction due to an increase in the signal light power increases. Specifically, the optical attenuator 180 acquires, from the Raman optical amplifier 130, information on the signal light power at which the gain reduction amount due to the saturation of the Raman gain, is equal to or larger than a predetermined threshold, for example. The optical attenuator 180 attenuates the input signal light and reduces the signal light power when the power of the input signal light is larger than the signal light power acquired from the Raman optical amplifier 130.

Regarding the gain reduction due to the saturation of the Raman gain, since the gain reduction amount increases as the signal light power increases, the gain reduction amount can be reduced if the signal light power input to the Raman optical amplifier 130 is reduced. Therefore, in the present embodiment, the optical attenuator 180 reduces the signal light power input to the Raman optical amplifier 130. The Raman optical amplifier 130 increases the Raman gain corresponding to the decrease in the signal light power, so that the quality deterioration of the signal light received by the optical reception device 200 can be suppressed.

As described above, according to the present embodiment, when the gain reduction due to the saturation of the Raman gain is large, the power of the signal light input to the Raman optical amplifier is reduced. It is thus possible to suppress the gain reduction due to the saturation of the Raman gain according to the signal light power, and suppress the quality deterioration of the signal light while reducing the compensation amount of the gain reduction.

The above-mentioned respective embodiments can be implemented by being combined as appropriate. Specifically, for example, the second and the third embodiments may be combined to create the gain reduction amount table 402 according to the characteristics of the optical fiber 150, and to optically amplify the signal light also in the optical reception device 200 if needed. In addition, for example, the second and the fourth embodiments may be combined to create the gain reduction amount table 402 according to the characteristics of the optical fiber 150, and to reduce the power of the signal light input to the Raman optical amplifier 130 if needed. Furthermore, for example, the third and the fourth embodiments may be combined to reduce the power of the signal light input to the Raman optical amplifier 130, and to optically amplify the signal light in the optical reception device 200. Moreover, the respective embodiments can be combined in various combinations.

According to one aspect of an optical amplifier, an optical transmission device, and an optical transmission system disclosed in the present application, it is possible to suppress deterioration of signal quality due to gain saturation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical amplifier comprising:
a light source that generates excitation light in a wavelength band for Raman-amplifying signal light;
an input unit that inputs the signal light and the excitation light to an optical fiber; and
a processor connected to the light source, wherein
the processor executes a process comprising:
acquiring a gain reduction amount of Raman amplification according to power of the signal light input to the optical fiber;
determining a target gain based on the gain reduction amount acquired;
judging whether a Raman gain corresponding to power of spontaneous emission light generated when the signal light is Raman-amplified in the optical fiber achieves the target gain determined; and
setting power of the excitation light according to a judging result at the judging.

2. The optical amplifier according to claim 1, wherein the light source includes
a first light source that generates first excitation light in a wavelength band for Raman-amplifying the signal light, and
a second light source that generates second excitation light in a wavelength band for Raman-amplifying the first excitation light.

3. The optical amplifier according to claim 2, wherein the process further comprises:
calculating a Raman gain for the first excitation light Raman-amplified in the optical fiber; and
measuring a change in the calculated Raman gain in a case of changing power of the first excitation light, and storing a gain reduction amount according to the power in a memory, wherein
the acquiring includes acquiring the gain reduction amount according to the power of the signal light input to the optical fiber from the memory.

4. An optical transmission device comprising:
a detector that detects power of a signal light; and
an optical amplifier that optically amplifies the signal light, wherein
the optical amplifier includes:
a light source that generates excitation light in a wavelength band for Raman-amplifying the signal light;
an input unit that inputs the signal light and the excitation light to an optical fiber; and
a processor connected to the light source, wherein
the processor executes a process comprising:
acquiring a gain reduction amount of Raman amplification according to the power detected by the detector;
determining a target gain based on the gain reduction amount acquired;
judging whether a Raman gain corresponding to power of spontaneous emission light generated when the signal light is Raman-amplified in the optical fiber achieves the target gain determined; and
setting power of the excitation light according to a judging result at the judging.

5. The optical transmission device according to claim 4, further comprising
an optical attenuator that attenuates the power of the signal light input to the detector when the power of the signal light input to the detector is larger than the power of the signal, light with which the gain reduction amount acquired is equal to or larger than a predetermined threshold.

6. An optical transmission system comprising an optical sending device and an optical reception device connected through an optical fiber, wherein
the optical sending device includes:
a detector that detects power of a signal light; and
an optical amplifier that optically amplifies the signal light, wherein
the optical amplifier includes:
a light source that generates excitation light in a wavelength band for Raman-amplifying the signal light;
an input unit that inputs the signal light and the excitation light to the optical fiber; and
a processor connected to the light source, wherein
the processor executes a process comprising:
acquiring a gain reduction amount of Raman amplification according to the power detected by the detector;
determining a target gain based on the gain reduction amount acquired;
judging whether a Raman gain corresponding to power of spontaneous emission light generated when the signal light is Raman-amplified in the optical fiber achieves the target gain determined; and
setting power of the excitation light according to a judging result at the judging, and
the optical reception device receives the signal light that is Raman-amplified and propagated in the optical fiber.

7. The optical transmission system according to claim 6, wherein
the optical reception device includes a receiver side optical amplifier that optically amplifies the received signal light with a gain corresponding to an insufficient gain in the optical amplifier.
